(19) United States
(12) Patent Application Publication
(10) Pub. No.: US 2010/0107838 A1
(43) Pub. Date: May 6, 2010

(54) WORK BENCH FOR CUTTING A TUBE AND METHOD USING SUCH WORK BENCH

(76) Inventors: Ola Berg, Forslov (SE); Berndt Einarsson, Angelholm (SE)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 12/519,370

(22) PCT Filed: Dec. 18, 2007
(86) PCT No.: PCT/SE2007/051021

§ 371 Date: Jan. 5, 2010

Related U.S. Application Data
(60) Provisional application No. 60/875,632, filed on Dec. 19, 2006.

(30) Foreign Application Priority Data
Dec. 19, 2006 (SE) 0602752-8

(51) Int. Cl. B26D 3/16; B25H 1/04

(52) U.S. Cl. 83/54; 83/648; 83/468; 83/468.7

(57) ABSTRACT

A work bench for cutting a tube comprises a support structure (2) for supporting the tube, a holder assembly (12) for holding the tube and a tool assembly (5) for cutting the tube (34). The tool assembly (5) comprises a cutting tool (8) which is restrained to move only in a plane perpendicular to a longitudinal direction of the tube (34), and that the holder assembly (12) comprises an abutment (16, 19) for an end of the tube (34). The abutment is movable in relation to the cutting tool (8) for setting a desired length of the tube (34) to be cut, and fixable to fix the position of the end of the tube (34) in relation to the cutting tool (8). A method for cutting a tube is also disclosed.

### TECHNICAL FIELD OF THE INVENTION

The present invention relates to a work bench for cutting a tube, comprising a support structure for supporting the tube, a holder assembly for holding the tube and a tool assembly for cutting the tube. The present invention also relates to a method for cutting a tube using a work bench provided with a cutting tool arranged on an articulated arm.

### BACKGROUND ART

When assembling ventilation systems it is very often necessary to cut the tubes into the desired length. This cutting is usually done with the tube placed on the floor. The fitter measures up the desired length on the tube with a carpenter's rule and makes a few marks along the circumference of the tube with a pencil. The fitter then uses a knife to hammer a hole into the tube at one of the marks. A drilling machine may also be used for making the hole, but the drilling machine is normally also used as a screw driver when assembling the tubes, and therefore it is necessary to frequently change from drill to screw bit and back again, or to have two different drilling machines. Handheld power-driven plate shears are inserted into the hole and the tube is cut by free-hand cutting, aided by the pencil marks. A drawback of this known cutting method is that the resulting cut is rarely straight and perpendicular to the longitudinal axis of the tube. This may make it difficult to connect tubes to each other, especially when using particular connection systems requiring a specifically straight and perpendicular cut. Another drawback is the uncomfortable working posture, which is a serious problem due to the numerous cuts made each working day by a ventilation fitter. Further, it is difficult to hold the carpenter's rule while making the marks.

Regular work benches used by, e.g., carpenters can also be used as a work surface when cutting tubes for a ventilation system. This may create a more comfortable working posture, but a drawback of such work benches is that they are bulky and heavy and therefore not easy to move around on a work site. In particular, it is difficult to move such workbenches through door openings. The drawbacks connected to free-hand cutting are the same as when cutting on the floor.

Special workbenches for cutting pipes or tubes, in particular tubes for ventilation duct systems, have therefore been developed. One example of such a specialised work bench is described in WO 99/29473. This work bench has an angle grinder with a rotating cutting disc arranged on a pivotable arm. Since the angle grinder is mounted on the work bench it is easier to make straight cuts. However, it is still necessary to use a separate carpenter's rule for measuring up the desired length of the tube to be cut. Once the desired length has been marked on the tube, the tube has to be held by hand in the correct position for the correct length to be cut. Additionally, if the tube is rotated during cutting, it has a tendency to wander along the workbench.

This is especially true in the case of lock seam tubes, because the lock seam catches on the rollers of the work bench. Further, angle grinders are in many cases not a very attractive option for cutting tubes for ventilation systems. This is especially true when working indoors, which is often the case when assembling ventilation duct systems. Angle grinders are very noisy, thereby giving rise to a risk of hearing impairment and necessitating hearing protectors. Further, cutting with an angle grinder creates sparks, thus representing a fire hazard. Because of its working principle, an angle grinder gives rise to burr on the inside of the cut tube. Therefore, the inside of the tube has to be deburred before the tubes are connected to each other. Otherwise the burr may damage sealing rings and the like. Unfortunately, this known work bench is not particularly flexible when it comes to the choice of cutting tool.

### SUMMARY OF THE INVENTION

It is an object of the invention to provide a work bench which solves, or at least lessens, the problems mentioned above.

It is a specific object of the invention to provide a work bench that makes it easy to achieve straight cuts when cutting tubes.

Another object of the invention is to provide a work bench that provides an ergonomically sound working posture.

A further object of the invention is to provide a work bench that makes it possible to cut tubes without creating burr on the inside of the tube and without creating excessive noise or dangerous sparks.

These objects are achieved by means of a work bench as claimed in claim 1, preferred embodiments thereof being defined in dependent claims 2-15.

These objects are also achieved by a method for cutting a tube as claimed in claim 16, a preferred variant of the method being defined in claim 17.

The work bench of the invention comprises a cutting tool which is restrained to move only in a plane perpendicular to a longitudinal direction of the tube, and the holder assembly comprises an abutment for an end of the tube, said abutment being movable in relation to the cutting tool for setting a desired length of the tube to be cut, and fixable to fix the position of the end of the tube in relation to the cutting tool. This work bench makes it possible to ensure a straight cut, which is perpendicular to the tube and in the correct position.

In one embodiment, the work bench comprises a first articulated arm carrying a knife edge and a second articulated arm carrying the cutting tool. The articulated arms make it possible to ensure that the knife edge and cutting tool can be moved easily, but only in a plane perpendicular to the longitudinal direction of the tube. The knife edge makes it possible to make a distinct hole for insertion of the cutting tool.

The cutting tool is preferably a scissor tool. The fact that a scissor tool is used makes it possible to avoid burr on the inside of the tube. Further, a scissor tool does not create dangerous sparks.

The scissor tool is preferably a pair of power-driven plate shears. This is a highly efficient tool forcutting tubes, without creating sparks and excessive noise.

In one embodiment, the second articulated arm has three pivot points. This makes it possible to particularly easy adapt to different dimensions of tubes and to manoeuvre the scissor tool while cutting.

The work bench may comprise a telescopic scale for setting and fixing the length of the tube to be cut. Hereby, the need of a separate carpenter's rule, which is difficult to hold still while marking off the length, is eliminated. Further, a straight cut at the right length is ensured.

The work bench may advantageously comprise two telescopic scales at opposite ends of the work bench for setting and fixing the length of the tube to be cut. In this way, it is easy to measure tubes of different cut length and to ensure that the cut is straight and in the correct position.

In one embodiment of the invention, the holder assembly comprises a first set of rollers arranged on a first carrier. This arrangement ensures a secure support of the tube and makes it easy to rotate the tube while cutting.

The first carrier is preferably fixed in position in relation to said tool assembly, whereby it is easy to ensure that the cut is made in the right position. The first carrier also ensures that the tube is securely supported on both sides of the cut.

The holder assembly may further comprise a second set of rollers arranged on a second, movable carrier providing an abutment for an end of the tube, thus making it possible to hold the tube more securely.

The second carrier is preferably arranged at an end of the work bench, and a third set of rollers is preferably arranged on a third, movable carrier at an opposite end of the work bench, arranged to receive an end of the tube. In this manner, tubes of different original length may be cut in an effective way.

The holder assembly may further comprise a fourth set of rollers arranged on a fourth, movable carrier, thus creating an additional, adjustable support surface for the tube.

In one embodiment of the invention, each set of rollers consists of four rollers arranged in pairs for accommodating tubes of different dimensions. Thus, different tube dimensions can be accommodated without a need for adjustments of the rollers.

The support structure may comprise foldable legs, thus making the work bench easy to transport and stow.

The support structure preferably comprises a wheel for transporting the work bench. The work bench is thereby easy to move around on a work site and to transport.

In the inventive method for cutting a tube an abutment provided on the work bench is moved in relation to the cutting tool for setting a desired length of the tube to be cut, the abutment is fixed in the position corresponding to the desired length of the tube to be cut, and the tube is cut with the cutting tool, the cutting tool being restrained by the first articulated arm to move only in a plane perpendicular to a longitudinal direction of the tube. With this method it is possible to ensure a straight cut in the right position on the tube.

In a variant of the inventive method the cutting tool used is a scissor tool, said method further comprising the step of cutting a hole with a knife edge in the tube for the scissor tool before cutting the tube, said knife edge being arranged on a second articulated arm (on the work bench. The hole made by the knife makes it easy to insert the scissor tool. Further, the use of a scissor tool eliminates the creation of burr on the inside of the tube and also eliminates the creation of dangerous sparks.

### BRIEF DESCRIPTION OF THE DRAWINGS

The invention will be described in more detail with reference to the appended schematic drawings, which show an example of a presently preferred embodiment of the invention.

FIG. 1 is a perspective view of a work bench according to the invention.

FIG. 2 is a side view of the tool assembly of the work bench in FIG. 1.

FIG. 3 is a perspective view of a part of the holder assembly of the work bench of FIG. 1

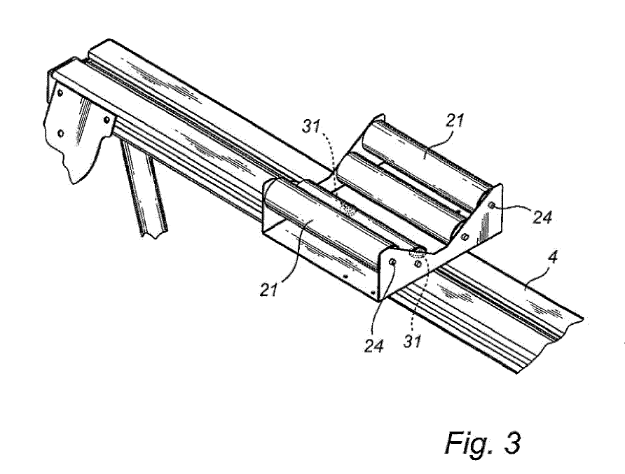

FIG. 4 is a perspective view of the knife edge of the work bench of FIG. 1.

FIG. 5 is a perspective view showing the work bench with a tube on it.

### DETAILED DESCRIPTION OF PREFERRED EMBODIMENTS OF THE INVENTION

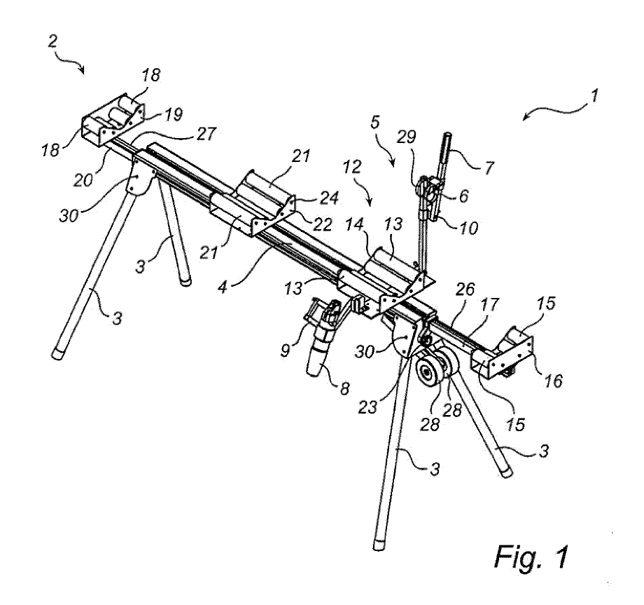

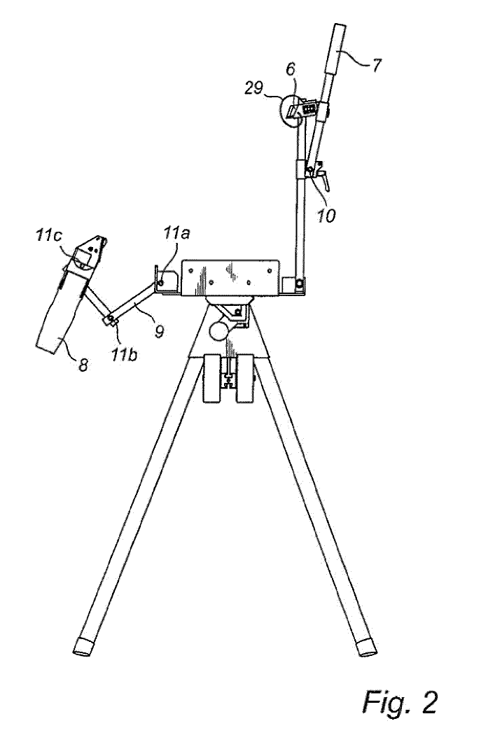

The work bench 1 shown in FIG. 1 is specifically designed for cutting tubes for ventilation duct systems, in particular helically wound lock seam tubes. The work bench 1 has a support structure 2 in the form of four foldable legs 3 and a bench surface 4. On the support structure 2 a tool assembly 5 is mounted. The tool assembly 5 consists of a knife edge 6 arranged on a pivotable arm 7 and power-driven plate shears 8 mounted on an articulated arm 9. The pivotable arm 7 on which the knife edge 6 is mounted has one pivot point 10. The articulated arm 9 on which the plate shears 8 are mounted has three pivot points 11a, 11b, 11c, as can be seen more clearly in FIG. 2.

The work bench 1 also has a holder assembly 12 for holding the tube to be cut. The holder assembly 12 is made up of a number of sets of rollers arranged in carriers. A first set of four rollers 13 is arranged in a first carrier 14 next to the tool assembly 5. The position of the first carrier 14 is fixed in relation to the tool assembly 5. A second pair of four rollers 15 is arranged a second carrier 16, which is mounted on a first telescopic part 17 that can be extracted from one end of the support structure 2 to extend the bench surface 4. A third set of four rollers 18 is arranged in a third carrier mounted on a second telescopic part, which is extractable from the opposite end of the support structure 2 for extending the bench surface 4. A fourth set of four rollers 21 is arranged in a fourth carrier 22 which is slidably mounted on the bench surface 4. Since there are four rollers on each carrier, the work bench can securely support tubes of differing dimension without a need for any adjustments to accommodate different tube dimensions. The rollers 13, 15, 18, 21 of each carrier 14, 16, 19, make it possible to rotate the tube 34 easily during cutting.

The work bench is provided with two measuring scales 26, 27, one on each telescopic part 17, 20, for measuring the tubes to be cut. A locking knob 23 is arranged at each end of the work bench 1 for locking the respective telescopic part 17, 20 in a desired position (only one of the locking knobs 23 is shown on the drawings). The locking knobs 23 can also be used for locking the telescopic parts 17, 20 in the completely retracted position for transporting the work bench 1.

For facilitating transportation on a work site, the work bench has two wheels 28 mounted at one end of the support structure 2.

For the sake of worker safety, the knife edge 6 is provided with a safety device in the form of two spring blades 29 covering the knife edge 6 when it is not in use.

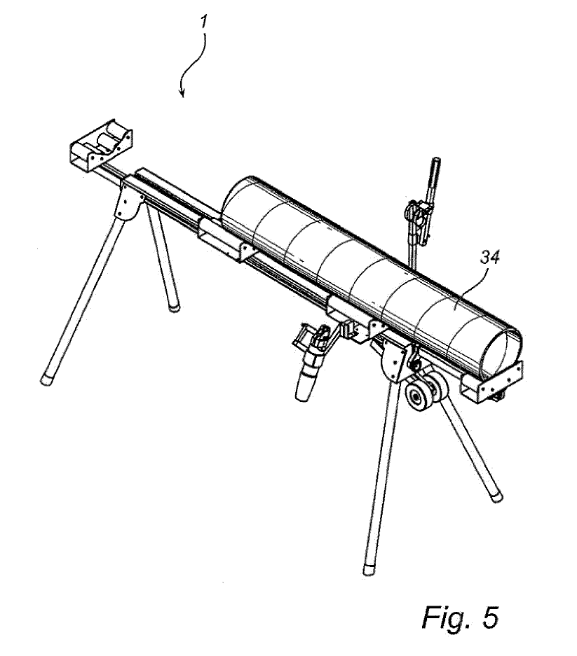

Tubes for ventilation duct systems are often delivered in lengths of 3 m. When a tube 34 is to be cut to a desired length to fit in the ventilation duct system being assembled, the tube 34 is placed on the work bench 1, resting on the rollers 13, 15, 18, 21 (see FIG. 5).

The first telescopic part 17 is pulled out of the work bench 1 until the scale 26 shows the desired length to be cut and the first telescopic part 17 is locked in this position by means of the locking knob 23. The tube 34 is placed with one end resting against the side of the second carrier 16 at one end of the work bench 1 to create an abutment. In this manner, the tube 34 is held securely in place, such that a straight cut in the right position can be ensured. The pivotable arm 7 is pivoted in order to place the knife edge 6 against the outside of the tube 34 and a hole is cut in the tube 34 with the spring blade 29 deflected. The pivotable arm 7 is then raised again to return the knife edge 6 to its original position. When a hole has been cut in the tube 34 the plate shears 8 are inserted into the hole and the tube 34 is slowly rotated while cutting with the plate shears 8, such that the desired length of tube 34 is cut. The plate shears 8 cut away a thin strip of the sheet metal of the tube 34, approximately 5-10 mm in width. The fact that the knife edge 6 and plate shears 8 are mounted on arms fixed on the bench surface 4 makes it possible to ensure a straight cut, which cannot be achieved by free-hand cutting. The arms 7, 9 only allow movement of the knife edge 6 and plate shears 8 in a plane perpendicular to the tube 34. Thus, the plate shears 6 cannot accidentally deviate from the desired straight cut. Further, the abutment of the end of the tube 34 against the side of the first carrier 14 or second carrier 16 ensures that the tube is fixed in the correct position for the desired length of tube to be cut.

Since the articulated arm 9 has three pivot points 11a-c, the plate shears 9 can be used for different dimensions of tube 34 and the plate shears 8 can be maneuvered appropriately while cutting as the tube 34 is rotated and the lock seam is encountered. The work bench 1 with its tool assembly 5 and holder assembly 12 is especially adapted for tubes with diameters of 80 to 315 mm, but it may of course be designed for other dimensions.

When a longer length of tube is to be cut, the second scale 27 at the opposite end of the work bench 1 is used for measuring. An end of the tube is suitably placed in the third carrier 19 abutting the side of the carrier 19. The position of the fourth carrier 22 can be adjusted by sliding the carrier 22 along the bench surface 4.

Because of the strip of metal cut away by the plate shears 8, the second scale 27 has to be adapted accordingly such that the desired length of tube 34 can be measured up and fixed regardless of which scale 26, 27 is used.

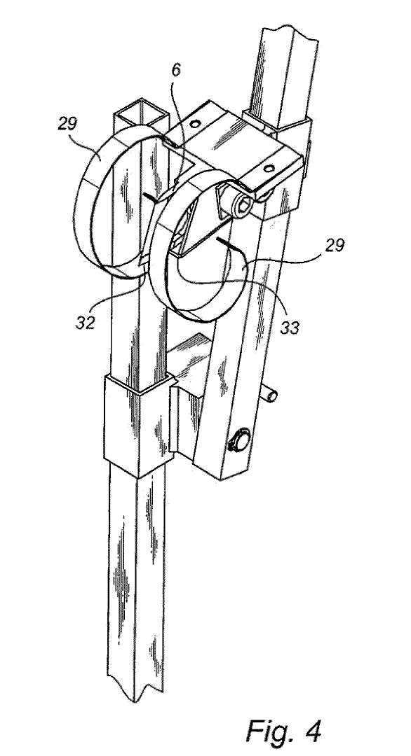

The knife edge 6 is shown in greater detail in FIG. 4. The forward face 32 of the knife edge 6 is straight and the knife edge 6 is equipped with a stop 33. This makes it possible to ensure a suitable shape of the hole cut by the knife edge 6. The resulting hole has the shape of an isosceles triangle, where the sheet metal is bent down to form the two equal sides of the triangle. The width of the base of the triangle is adapted by means of the stop 33 such that all the bent-down sheet metal is cut away by the plate shears 8 when the cut is finished. If the base of the triangle is too wide, the plate shears 8 will not be able to cut away all the bent-down sheet metal and the cut will not be neat. The knife edge 6 can be adjusted with respect to how far into the knife holder 35 it is inserted. This adjustment makes it possible to adapt the hole made to different plate shears and to account for wearing of the knife edge 6. Further, the position of the pivotable arm 7 can be adjusted in height for suiting tubes 34 of different dimensions. This height adjustment is preferably done with a locking mechanism requiring only one hand for operation.

The work bench 1 is suitably also equipped with special cutting pliers (not shown) for cutting off sharp points that are created when a lock seam is cut through at a non-perpendicular angle. These special pliers cut through the lock seam, but not through the underlying layer of sheet metal. The cutting pliers may be attached to the work bench 1 near the tool assembly 5 by means of, e.g., a length of chain or may be placed in a pocket or box attached to the workbench 1.

The plate shears 8 can easily be removed from the articulated arm 9 for free-form cutting, e.g., of holes in the tube 34 for collar saddles and the like.

When the work bench 1 is to be transported, the legs 3 are folded in using pivot points 30 in the connection to the bench surface 4. The legs 3 are locked in the folded position, such that they are not accidentally folded out during transportation. Correspondingly, when the work bench 1 is in use, the legs 3 are locked in the folded-out position. Using the wheels 28, the folded work bench 1 can easily be moved around by one person and even fit into a car. The wheels 28 are small enough not to be cumbersome when the work bench 1 is in use or is stored, but large enough to be able to clear doorsills.

The rollers 13 next to the tool assembly 5 are suitably fairly long, e.g. 20 cm. In this manner the tendency of the tube 34 to wander along the length of the bench surface 4 is eliminated. The rollers 15, 18 on the telescopic parts 17, 20 are preferably fairly short, e.g. 10 cm, thus minimising the minimal length of tube that may be cut.

The skilled person realises that a number of modifications of the embodiments described herein are possible without departing from the scope of the invention, which is defined in the appended claims.

For instance, the knife edge 6 may be replaced by a drilling machine for making a hole in the tube 34 before 10 cutting.

The plate shears 8 may be replaced by another cutting tool, e.g. a nibbler, a circular saw with one or two blades, a jig saw or an angle grinder. It is preferable to use a tool that does not give rise to burr on the inside of the tube and for work indoors it is preferable to use a tool that does not create dangerous sparks.

The legs of the work bench may be telescopically extendable to suit fitters of different height.

The articulated arm 9 carrying the plate shears 8 may have more than three pivot points and may for instance be a chain that does not allow sideways movement, i.e. movement of the plate shears along the length of the bench surface 4, or rotation other than in the plane perpendicular to the length of the tube 34.

The carriers 14, 16, 19, 22 may instead of four rollers 13, 15, 18, 21 each have only two rollers each. In this case, the carriers 14, 16, 19, 21 in each side has two sets of slots (not shown) for receiving the shafts 24 of the rollers 21. There is preferably three slots in each set and these slots are connected by a track (not shown). The rollers 13, 15, 18, 21 can be placed in one of three positions in relation to each other, corresponding to the three slots. For a tube 34 with a larger dimension, the rollers 13, 15, 18, 21 in each carrier 14, 16, 19, 22 are moved as far apart as possible and for a tube 34 with a smaller dimension the rollers 13, 15, 18, 21 are moved as close together as possible. The third, intermediate slot is suited for intermediate tube dimensions. Because of the track connecting the slots the rollers can easily be moved from one position to another. The track is preferably not open outwards, thus ensuring that the rollers 13, 15, 18, 21 are securely held in the carriers 14, 16, 19, 22 and cannot accidentally fall off, for instance during transportation of the work bench 1. The provision of adjustable rollers reduces then number of components of the work bench, and thus the cost of manufacturing and the weight. Apart from tubes for ventilation duct systems, the work bench 1 may also be used for cutting other tubes. The cutting tool is advantageously chosen to suit the type of tube to be cut.

1. A work bench for cutting a tube (34), comprising a support structure (2) for supporting the tube (34), a holder assembly (12) for holding the tube and a tool assembly (5) for cutting the tube (34), wherein the tool assembly (5) comprises a cutting tool (8) which is restrained to move only in a plane perpendicular to a longitudinal direction of the tube (34), and that the holder assembly (12) comprises an abutment (16, 19) for an end of the tube (34), said abutment being movable in relation to the cutting tool (8) for setting a desired length of the tube (34) to be cut, and fixable to fix the position of the end of the tube (34) in relation to the cutting tool (8).

2. A work bench as claimed in claim 1, wherein said tool assembly (5) comprises a first articulated arm (7) carrying a knife edge (6) and a second articulated arm (9) carrying the cutting tool (8).

3. A work bench as claimed in claim 1 claim 1, wherein said cutting tool is a scissor tool (8).

4. A work bench as claimed in claim 3, wherein said scissor tool is a pair of power-driven plate shears (8).

5. A work bench as claimed in claim 2, wherein the second articulated arm (9) has three pivot points (11a-c).

6. A work bench as claimed in claim 1, further comprising a first telescopic scale (26) for setting and fixing the length of the tube (34) to be cut.

7. A work bench as claimed in claim 1, comprising a first telescopic scale (26) and a second telescopic scale (27) at opposite ends of the work bench (1) for setting and fixing the length of the tube (34) to be cut.

8. A work bench as claimed in claim 1, wherein the holder assembly (12) comprises a first set of rollers (13) arranged on a first carrier (14).

9. A work bench as claimed in claim 8, wherein said first carrier (14) is fixed in position in relation to said tool assembly (5).

10. A work bench as claimed in claim 8, wherein said holder assembly (12) further comprises a second set of rollers (15) arranged on a second, movable carrier (16) providing an abutment for an end of the tube (34).

11. A work bench as claimed in claim 10, wherein said second carrier (16) is arranged at an end of the work bench (1) and wherein a third set of rollers (18) is arranged on a third, movable carrier (19) at an opposite end of the work bench (1), providing an abutment for an end of the tube (34).

12. A work bench as claimed claim 8, wherein said holder assembly (12) further comprises a fourth set of rollers (21) arranged on a fourth, movable carrier (22).

13. A work bench as claimed in claim 8, wherein each set of rollers consists of four rollers (13, 15, 18, 21) arranged in pairs for accommodating tubes (34) of different dimensions.

14. A work bench as claimed in claim 1, wherein the support structure (2) comprises foldable legs (3).

15. A work bench as claimed in claim 1, wherein the support structure (2) comprises a wheel (28) for transporting the work bench (1).

16. A method for cutting a tube (34), using a work bench (1) provided with a cutting tool arranged on a second articulated arm (9), wherein:
an abutment (16, 19) provided on the work bench (1) is moved in relation to the cutting tool (8) for setting a desired length of the tube (34) to be cut;
the abutment (16, 19) is fixed in the position corresponding to the desired length of the tube (34) to be cut; and
the tube (34) is cut with the cutting tool (8), the cutting tool (8) is being restrained by the second articulated arm (9) to move only in a plane perpendicular to a longitudinal direction of the tube (34).

17. A method as claimed in claim 16, wherein the cutting tool used is a scissor tool (8), said method further comprising the step of cutting a hole with a knife edge (6) in the tube (34) for the scissor tool (8) before cutting the tube (34), said knife edge (6) being arranged on a first articulated arm (10) on the work bench (1).
